(19) United States
(12) Patent Application Publication
(10) Pub. No.: US 2026/0332604 A1
(43) Pub. Date: Oct. 22, 2026

(54) APPARATUS AND METHOD FOR DETECTING CYBERATTACK

(71) Applicant: ELECTRONICS AND TELECOMMUNICATIONS RESEARCH INSTITUTE, Daejeon (KR)

(72) Inventor: Kyeong-Tae KIM, Daejeon (KR)

(73) Assignee: ELECTRONICS AND TELECOMMUNICATIONS RESEARCH INSTITUTE, Daejeon (KR)

(21) Appl. No.: 19/072,688

(22) Filed: Mar. 6, 2025

(30) Foreign Application Priority Data
Jul. 5, 2024 (KR) 10-2024-0088868

(51) Int. Cl. H04L 9/40

(52) U.S. Cl. CPC H04L 63/1416

(57) ABSTRACT

Disclosed herein is an apparatus and method for detecting a cyberattack. The apparatus may include an attention extraction unit for extracting at least one critical event based on the probabilities that pieces of input time-series event data in a predetermined sliding window unit contribute to occurrence of a subsequent event and an attack grouping unit for clustering cyberattack characteristics based on the extracted at least one critical event.

### CROSS REFERENCE TO RELATED APPLICATION

This application claims the benefit of Korean Patent Application No. 10-2024-0088868, filed Jul. 5, 2024, which is hereby incorporated by reference in its entirety into this application.

### BACKGROUND OF THE INVENTION

### 1. Technical Field

The disclosed embodiment relates to technology for analyzing and responding to cyberattacks.

### 2. Description of the Related Art

Security information and event management (SIEM) technology provides real-time monitoring and event analysis functions by combining security information management (SIM) and security event management (SEM) and tracks and logs security data for compliance with regulations and auditing requirements. That is, SIEM is a solution that helps organizations detect, analyze, and respond to security threats before potential cyberattack problems are posed.

However, cases in which administrators for managing SIEM receive 100,000 or more security alarm alerts per day account for over 50% of all security alarm alerts. Too many security alarm alerts result in an alert fatigue problem, and this is too serious for people to handle.

### SUMMARY OF THE INVENTION

An object of the disclosed embodiment is to solve an alert fatigue problem attributable to security alarm alerts.

Another object of the disclosed embodiment is to identify a critical event based on characteristics of a series of time-series attack packets.

A further object of the disclosed embodiment is to identify a critical event based on the correlation between time-series attack packets input from multiple devices.

An apparatus for detecting a cyberattack according to an embodiment may include an attention extraction unit for extracting at least one critical event based on probabilities that pieces of input time-series event data in a predetermined sliding window unit contribute to occurrence of a subsequent event and an attack grouping unit for clustering cyberattack characteristics based on the extracted at least one critical event.

Here, the attention extraction unit may include an embedding unit for converting the pieces of input time-series event data into predetermined vectors, respectively, and at least one Temporal Convolutional Network (TCN) for extracting time-series characteristics of the vectors.

Here, the attention extraction unit may include a local attention unit for extracting a critical event from pieces of time-series event data included in a context input from a single device.

Here, the attention extraction unit may further include a global attention unit for extracting a critical event based on a correlation from pieces of time-series event data respectively included in multiple contexts input from multiple devices.

Here, the global attention unit may be configured with operations of two Squeeze-and-Excitation Networks (SE-NETs).

Here, the global attention unit may be configured with an Efficient Channel Attention Net (ECA-NET).

Here, the attention extraction unit may be trained in advance such that loss for the probability of occurrence of a final event is minimized after the sum of vectors of extracted critical events is normalized.

Here, the attack grouping unit may perform clustering into a group with a minimum distance between a cluster vector and an extracted attention vector.

Here, the attack grouping unit may cluster data in a latent space based on deep learning of a TCN Variational Auto Encoder (VAE) technique and may be configured with a TCN-VAE including an encoder for mapping time-series data into a low-dimensional latent space and a decoder for mapping a point in the latent space into an original data space.

Here, the apparatus for detecting a cyberattack according to an embodiment may further include a response mapping unit for recommending a response to an attack based on the MITRE ATT&CK Matrix mapped to a clustered group.

A method for detecting a cyberattack according to an embodiment may include extracting at least one critical event based on probabilities that pieces of input time-series event data in a predetermined sliding window unit contribute to occurrence of a subsequent event and clustering cyberattack characteristics based on the extracted at least one critical event.

Here, extracting the at least one critical event may include embedding the pieces of input time-series event data into predetermined vectors, respectively, and extracting time-series characteristics of the vectors through at least one Temporal Convolutional Network (TCN).

Here, extracting the at least one critical event may include performing local attention extraction for extracting a critical event from pieces of time-series event data included in a context input from a single device.

Here, extracting the at least one critical event may further include performing global attention extraction for extracting a critical event based on a correlation from pieces of time-series event data respectively included in multiple contexts input from multiple devices.

Here, performing the global attention extraction may be configured with operations of two SE-NETs.

Here, performing the global attention extraction may be configured with an Efficient Channel Attention Net (ECA-NET).

Here, extracting the at least one critical event may further include performing learning in advance such that loss for the probability of occurrence of a final event is minimized after the sum of vectors of extracted critical events is normalized.

Here, clustering the cyberattack characteristics may comprise performing clustering into a group with a minimum distance between a cluster vector and an extracted attention vector.

Here, clustering the cyberattack characteristics may comprise clustering data in a latent space based on deep learning of a TCN Variational Auto Encoder (VAE) technique and may be configured with a TCN-VAE including an encoder for mapping time-series data into a low-dimensional latent space and a decoder for mapping a point in the latent space into an original data space.

Here, the method for detecting a cyberattack according to an embodiment may further include recommending a response to an attack based on the MITRE ATT&CK Matrix mapped to a clustered group.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic block diagram of an apparatus for detecting a cyberattack according to an embodiment;

FIG. 2 is an exemplary view for explaining extraction of a critical event from time-series event data according to an embodiment;

FIG. 3 is an exemplary view of mapping of the MITRE ATT&CK Matrix to a cluster according to an embodiment;

FIG. 4 is a block diagram of the internal configuration of an attention extraction unit according to an embodiment;

FIGS. 5 and 6 are exemplary views of the internal configuration of a Temporal Convolutional Network (TCN) applied to an embodiment;

FIG. 7 is a view illustrating the internal configuration of an attention extraction unit according to an embodiment;

FIG. 8 is an exemplary view of a correlation context event;

FIGS. 9 to 11 are exemplary views for explaining a SE-NET applied to a global attention unit according to an embodiment;

FIG. 12 is an exemplary view for explaining an ECA-NET applied to a global attention unit according to another embodiment;

FIG. 13 is an exemplary view of attack grouping according to an embodiment;

FIG. 14 is an exemplary view of attack grouping according to another embodiment;

FIG. 15 is a flowchart for explaining a method for detecting a cyberattack according to an embodiment;

FIGS. 16 and 17 are views for explaining a clustering method using auto-encoder;

FIGS. 18 and 19 are views for explaining a clustering method using Temporal Convolutional Network Variational Auto Encoder (TCN-VAE);

FIGS. 20 and 21 are views for explaining a clustering method using TCN Adversarial Auto Encoder (TCN-AAE);

FIGS. 22 and 23 are views for explaining a clustering method using TCN Gaussian Mixture Model Wasserstein Generative Adversarial Network (TCN-GMM-WGAN);

FIGS. 24 and 25 are views for explaining a clustering method using conditional TCN-GMM-WGAN; and

FIG. 26 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

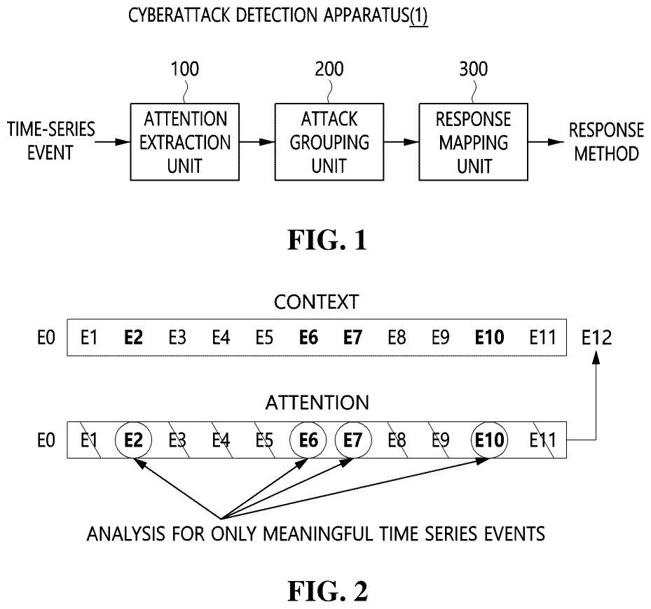

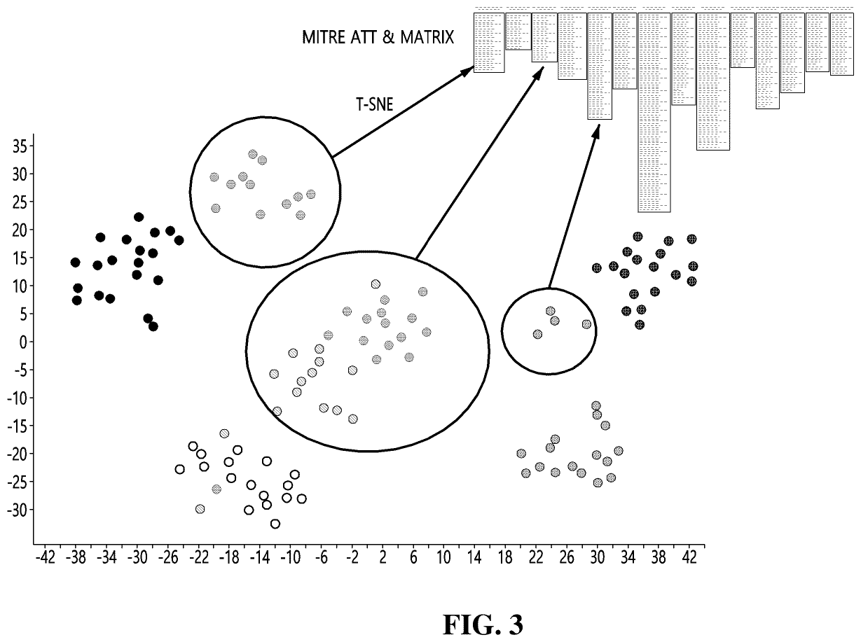

FIG. 1 is a schematic block diagram of an apparatus for detecting a cyberattack according to an embodiment, FIG. 2 is an exemplary view for explaining extraction of a critical event from time-series event data according to an embodiment, and FIG. 3 is an exemplary view of mapping of the MITRE ATT&CK Matrix to a cluster according to an embodiment.

Referring to FIG. 1, the apparatus 1 for detecting a cyberattack according to an embodiment includes an attention extraction unit 100 and an attack grouping unit 200 and accurately extracts and clusters the characteristics of a cyberattack in order to mitigate alert fatigue attributable to frequent alerts for notifying detection of a cyberattack.

The attention extraction unit 100 extracts at least one critical event based on the probabilities that pieces of input time-series event data in a predetermined sliding window unit contribute to the occurrence of a subsequent event.

A cyberattack is time-series data, and attackers execute specific commands (actions) in a time-ordered sequence. For example, attack actions such as ‘reconnaissance→vulnerability scanning→infiltration→privilege escalation→malicious code distribution→malicious code execution’ may occur in units of network packets.

For example, referring to FIG. 2, when sequential time-series events, such as E0, E1, . . . , E12, are input, the attention extraction unit 100 may set the range of a context (E1, . . . , E11) as a sliding window and extract attention events based on the possibility of E12 occurring.

Here, the time-series events may be normal events or attacks.

Also, although the size of the sliding window is set to 10, this is merely an example, and the present disclosure is not limited thereto. That is, the sliding window is a hyperparameter, and the value thereof may be changed.

In FIGS. 2, E2, E6, E7, and E10 seen as being likely to trigger E12 may be extracted as attention events, and E1, E3, E4, E5, E8, E9, E11 that are irrelevant to E12 may be excluded.

The probabilities of E2, E6, E7, and E10 contributing to the occurrence of E12 may be estimated. For example, the probabilities may be E2 (0.2), E6 (0.3), E7 (0.2), and E10 (0.3).

This data attention process is based on the self-attention mechanism proposed in the paper “Attention is all you need” by Vaswani, A., Shazeer, N., Parmar, N., Uszkoreit, J., Jones, L., Gomez, A. N., Kaiser, Ł., & Polosukhin, I. (2017), published in Advances in Neural Information Processing Systems (p./pp. 5998-6008).

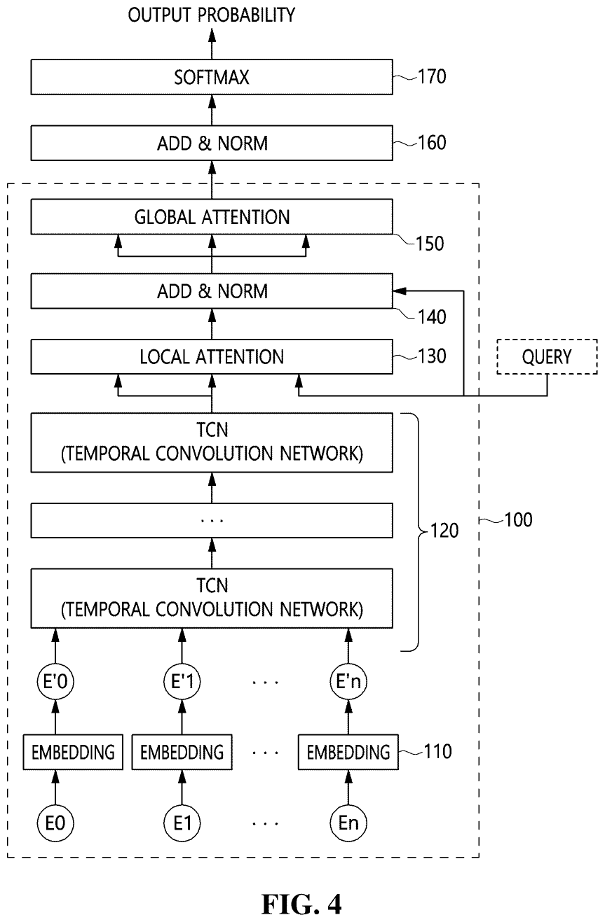

The attention extraction unit 100 will be described in detail later with reference to FIGS. 4 to 12.

The attack grouping unit 200 clusters cyberattack characteristics based on the extracted at least one critical event. That is, after the characteristics of a series of time-series attack packets are classified in advance through clustering, a series of attack actions is clustered into a specific cluster group in real time in the event of an attack.

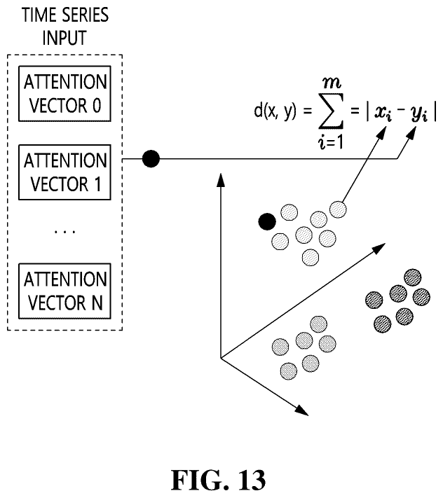

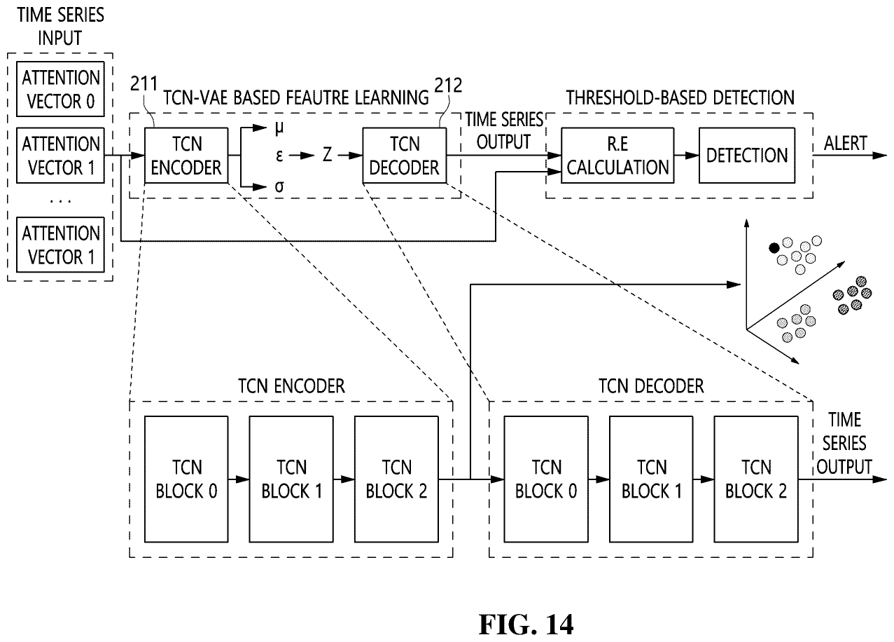

The attack grouping unit 200 will be described in detail later with reference to FIGS. 13 and 14.

Referring to FIG. 1, the apparatus 1 for detecting a cyberattack according to an embodiment may further include a response mapping unit 300.

The response mapping unit 300 may recommend a response to an attack based on an attack alarm and the MITRE ATT&CK Matrix mapped to a clustered group.

That is, referring to FIG. 3, the characteristics of the groups belonging to a cluster and the MITRE ATT&CK Matrix are mapped to each other and data is grouped into the cluster, whereby the characteristic of alerts about various cyberattacks may be provided to a SIEM administrator and a response to an attack may be automatically recommended.

Here, the MITRE Adversarial Tactics, Techniques, and Common Knowledge (ATT&CK) Matrix is a framework developed by the MITRE corporation and is a knowledge base and classification system that comprehensively categorizes and organizes tactics and techniques used by cyber attackers at various stages of a cyberattack. In the cybersecurity field, the MITRE ATT&CK Matrix is being widely used to understand and categorize tactics and techniques used by threateners infiltrating into networks and computer systems.

The main components and concepts of the MITRE ATT&CK Matrix are as follows.

1) Tactics: This matrix includes columns representing tactics that an attacker uses at various stages of an attack. The tactics are categorized into high-level goals, such as initial access, execution, persistence, privilege escalation, defense evasion, credential access, discovery, lateral movement, collection, exfiltration, and command and control.

2) Techniques: There is a specific technique that attackers use to achieve the goal of each tactic. For example, there is a technique such as “command line interface” in the “execution” tactic.

3) Procedure and Examples: For each technique, MITRE provides a description of the technique, use cases observed in real-world attacks, and references about known threat groups that have used the technique.

4) Mitigations: MITRE ATT&CK includes information about defensive strategies against each technique. The defensive strategies help organizations protect systems and networks from a specific attack technique.

5) Detection: This matrix also provides information about a method for detecting which attack technique is being used. This helps organizations identify and respond to potential threats.

The MITRE ATT&CK Matrix is an essential resource for organizations, security researchers, and cybersecurity professionals to understand cyberthreats and strengthen defense and is used as basic references about threat intelligence, incident responses, and security operations. As a threat environment changes, MITRE may update the matrix and add new tactics, techniques, and real-world observations.

So far, there is no known technology capable of automatically mapping the MITRE ATT&CK Matrix to a cyberattack.

However, according to the above-described embodiment, an action is taken against a corresponding attack according to a response method that a SIEM administrator sets for each clustered group, whereby alert fatigue may be mitigated. That is, the embodiment analyzes a single time-series event and categorizes the same with a large number of correlated events using AI clustering technology, so it may be used in various domains, including improvement in the accuracy of anomaly detection, reduction of alert fatigue, and proactive and predictive responses.

FIG. 4 is a block diagram of the internal configuration of an attention extraction unit according to an embodiment.

Referring to FIG. 4, the attention extraction unit 100 according to an embodiment may include an embedding unit 110 for converting pieces of input time-series event data to predetermined vectors, respectively.

That is, the embedding unit 110 embeds time-series events E0, E1, . . . , En into arbitrary vectors (automatically learned and embedded later), thereby converting the same into E′0, E′1, . . . , E′n.

Also, the attention extraction unit 100 according to an embodiment may further include at least one Temporal Convolutional Network (TCN) 120 for extracting time-series characteristics in which the time-ordered sequence of the vectors is important.

As a neural network model commonly used to handle time-series data, Long Short-Term Memory (LSTM), which is a type of Recurrent Neural Network (RNN), was dominant.

However, the use of a Temporal Convolutional Network (TCN), which is a type of CNNs but solves some problems with the CNNs, enables not only image data but also time-series data (in a numerical form) to be processed and enables features to be extracted. That is, it enables analysis of temporal time-series data, which is affected by a time-ordered sequence) while maintaining the advantages of the CNNs (sharing of learning parameters and extraction of local features).

Also, the RNNs process time-series data sequentially because parallel processing is impossible, and this causes the problems of gradient loss and divergence to occur during backpropagation in the learning process, but the TCNs may enable parallel processing and solve the problems caused during backpropagation.

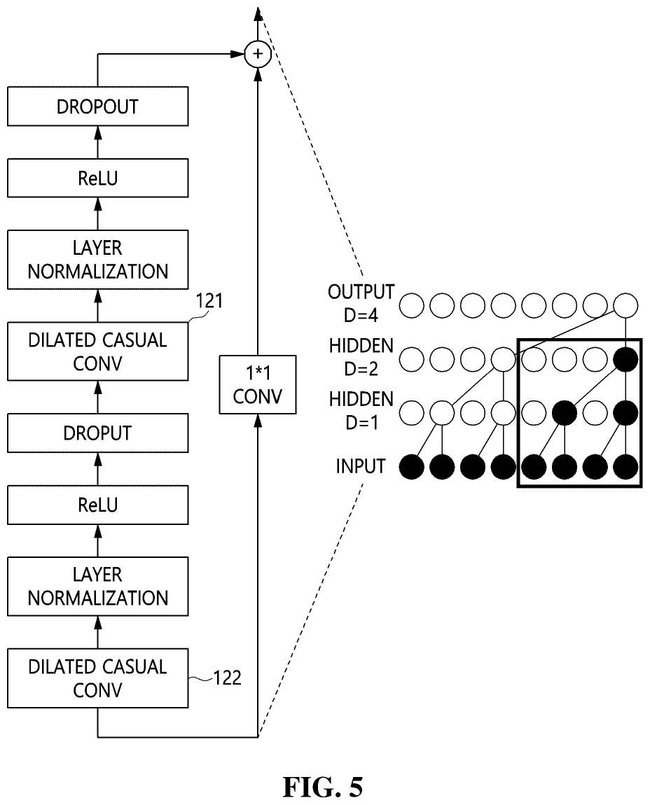

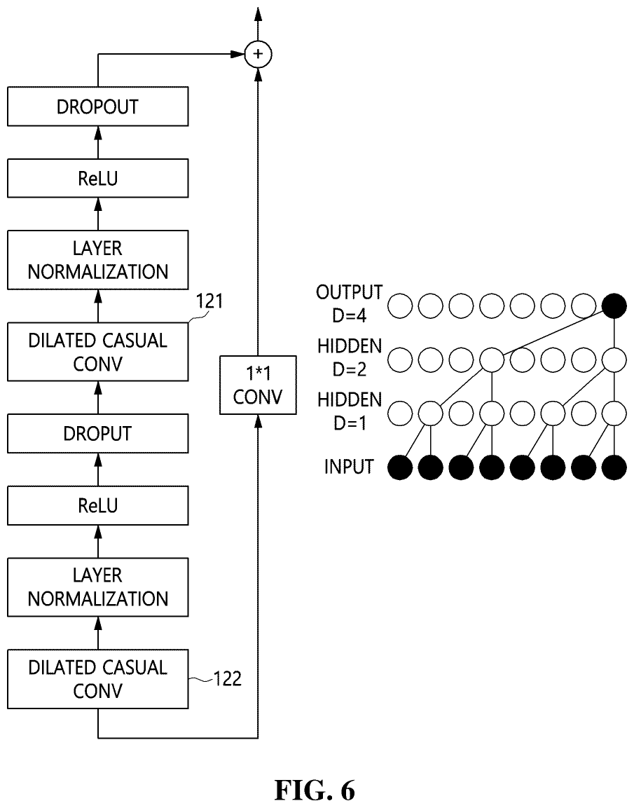

FIGS. 5 and 6 are exemplary views of the internal configuration of a Temporal Convolutional Network (TCN) applied to an embodiment.

Referring to FIGS. 5 and 6, the TCN processes sequence-to-sequence events using casual convolution and dilated convolution structures 121 and 122, in which case parallel processing is possible. Because of the simple structure thereof, the TCN enables high-speed learning and has superior performance, compared to RNNs.

That is, it can be seen that increasing the number of hidden layers (dilation=4) without increasing a kernel size (k=2) results in an expanded reception field (reception field=4).

Here, if the number of hidden layer (dilation=2) is added, the reception field becomes 8. Even with a larger number of parameters, setting the reception field to be wide enables more effective feature extraction. Therefore, the reception field may be flexibly expanded through the dilation factor. Also, the use of the causal convolution structure ensures that there is no information leakage from future to past.

The TCN receives sequences of different lengths and maps the same to an output sequence of an identical length.

In summary, the TCN (casual convolution and dilated convolution structures) is used to process sequence-to-sequence events and has an advantage in solving the inherent problem with RNNs, such as the impossibility of parallelization and difficulty in processing long input events. Therefore, in the embodiment, the TCN 120 is used to process time-series security events.

Referring again to FIG. 4, the attention extraction unit 100 includes a local attention unit 130 and a global attention unit 150.

First, an attention extraction process used in the local attention unit 130 and the global attention unit 150 will be described below.

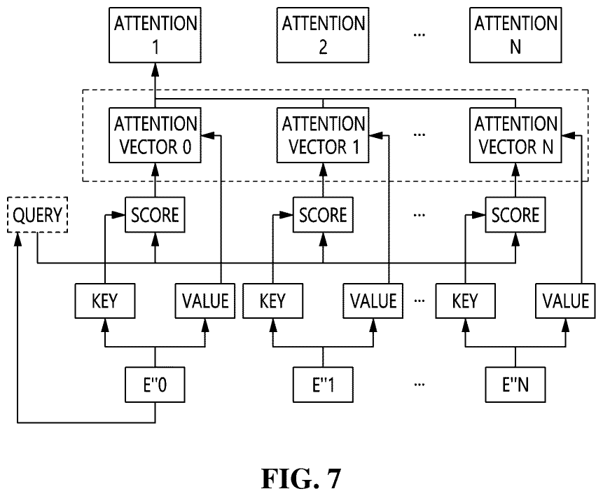

FIG. 7 is an exemplary view for explaining an attention extraction process according to an embodiment.

It is assumed that a user searches for the query “Apple watch SE price” based on a search engine that can only search a database containing information such as that shown in Table 1 below.

TABLE 1

(key1, val1) = (“Galaxy Z fold 2”, 2000000)
(key2, val2) = (“Apple Watch SE”, 399000)
(key3, val3) = (“iPhone 11”, 900000)

The search engine may perform calculation as shown in Table 2 below. First, for the same query, the similarity between each key and the query may be considered.

TABLE 2

similarity (query, key1) = 10
similarity (query, key2) = 400
similarity (query, key3) = 200

After the similarity is calculated in this way, the ranking may be determined as shown in Table 3 below in order to select the information to be first provided to the user.

TABLE 3
similarity (query, key2) = 400 > 399000 won < top-ranked document
similarity (query, key3) = 200 > 900000 won < second-ranked document
similarity (query, key1) = 10 > 2000000 won < third-ranked document

If it is intended to identify the relative similarity of each key and the ranking, each similarity score may be normalized to the total of similarity scores, as shown in Table 4 below.

TABLE 4

norm (similarity (query, key2)) = 400/610 > the probability
that the price is 399000 won is 67%
norm (similarity (query, key3)) = 200/610 > the probability
that the price is 900000 won is 32%
norm (similarity (query, key1)) = 10/610 > the probability
that the price is 2000000 won is 1%

Accordingly, the attention mechanism may find the answer to the query as shown in Table 5 below through the normalization of the similarity scores. Because the relative similarity of each key is known, the answer to the query may be represented using the weighted sum of all the values.

TABLE 5
query = “Apple Watch SE price”
answer = 399000 * 0.67 + 900000 * 0.32 + 2000000 * 0.01 = 575,330

Referring again to FIG. 4, the attention extraction unit 100 according to an embodiment may further include a local attention unit 130 for extracting a critical event from pieces of time-series event data included in the context input from a single device.

Also, the attention extraction unit 100 according to an embodiment may further include a global attention unit 150 for extracting a critical event based on the correlation from pieces of time-series event data respectively included in multiple contexts input from multiple devices.

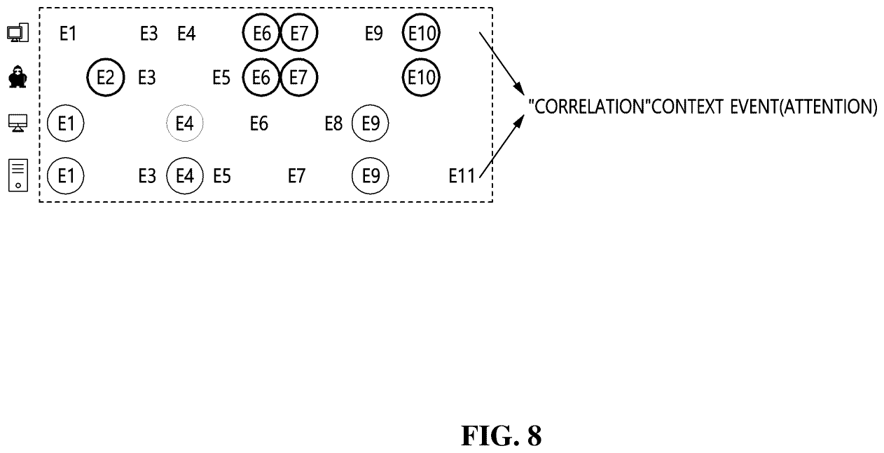

FIG. 8 is an exemplary view of a correlation context event.

When it receives not a single context but multiple contexts from various devices, as illustrated in FIG. 8, the global attention unit 150 may analyze the correlation between the contexts and extract attention. That is, the correlation (order, critical event, and normal/abnormal) of a diversity of attention is extracted through global attention.

According to an embodiment, the global attention unit 150 may be configured with a Squeeze-and-Excitation Network (SE-NET).

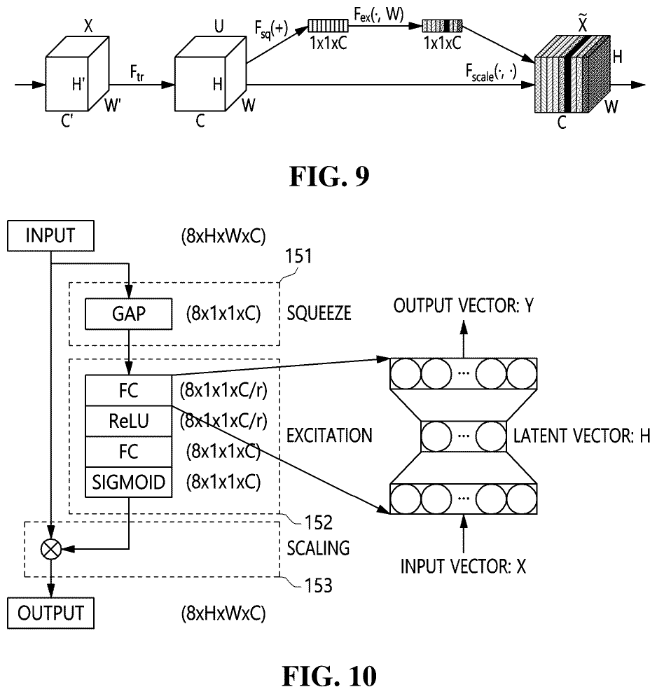

FIGS. 9 to 11 are exemplary views for explaining the SE-NET applied to the global attention unit 150 according to an embodiment.

Referring to FIGS. 9 and 10, a squeeze layer 151 receives a feature map generated through a convolution operation.

That is, a feature map of size H (Height)×W (Width)×C (Channel) is compressed into (1×1×C) through a global average pooling operation. By adding all pixel values corresponding to each channel of the feature map and dividing the result by (H×W), they are compressed into 1×1×1.

Because the feature map has C channels, when all of the channels are connected, (1×1×C) is formed, and the generated (1×1×C) vector is forwarded to an excitation layer 152.

The excitation layer 152 serves to normalize the (1×1×C) vector generated by the squeeze layer 151 and to assign weights thereto.

Here, the excitation layer 152 may be configured with FC1-ReLU-FC2-Sigmoid. That is, the (1×1×C) vector is input to FC1, and the number of channels is reduced from C to C/r.

r is a hyperparameter, and a bottleneck structure may be selected due to a limit to the amount of computation and a generalization effect. The (1×1×C/r) vector, the size of which is reduced due to the decrease in the number of channels (C/r), is transferred to the activation function ReLU and passes through the FC2 layer.

The FC2 layer restores the number of channels to C, and the result passes through the Sigmoid function to obtain a value within the range [0-1). Finally, the value is multiplied by the feature map to assign weights to the channels of the feature map.

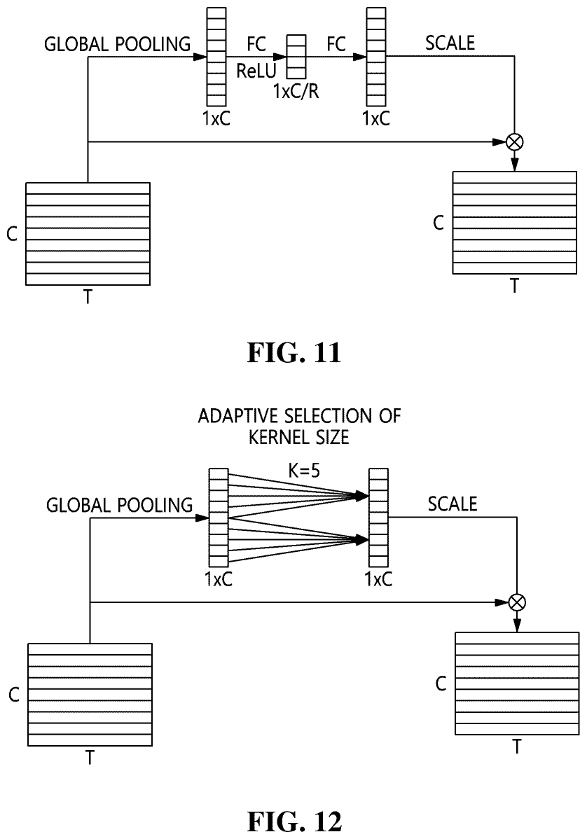

Referring to FIG. 11, the attention between multiple channels is used after passing through the TCN and local attention. Accordingly, when multiple contexts are input from various devices, the correlation of the contexts may be analyzed, and attention may be extracted.

C indicates channels, and T indicates time-series data.

According to another embodiment, the global attention unit 150 may be configured with an ECA-NET.

FIG. 12 is an exemplary view for explaining the ECA-NET applied to the global attention unit 150 according to another embodiment.

Referring to FIG. 12, in the Efficient Channel Attention Net (ECA-NET), after features are extracted through global pooling, channel attention is performed efficiently without dimensionality reduction by using a 1D convolution with a kernel size of K (K=5 in the example), rather than two FC layers in a SE-Net, whereby channel weights are calculated.

Without dimensionality reduction caused by the FC layer in the SE-Net, a direct association between channels and weights is obtained using only a 1D convolution, and model complexity may be reduced using a kernel that considers only surrounding local regions.

Referring again to FIG. 4, the attention extraction unit 100 may be trained in advance such that loss for the probability of occurrence of a final event is minimized after normalization of the sum of vectors of the extracted critical events.

That is, training is performed by adding and normalizing the attention vectors (160), calculating the probability of occurrence of the final event En+1 using the Softmax function 170, and minimizing the loss using a cross entropy method.

Meanwhile, the attack grouping unit 200 illustrated in FIG. 1 may be implemented as two embodiments.

According to an embodiment, the attack grouping unit 200 may perform clustering into a group with the minimum distance between a cluster vector and an extracted attention vector.

FIG. 13 is an exemplary view of attack grouping according to an embodiment.

Referring to FIG. 13, clustering may be performed to minimize the distance (Euclidean distance) between the existing cluster vector xᵢ formed through training and a real-time attention vector yᵢ input for testing.

Here, K-means clustering, mean-shift clustering, density-based spatial clustering of applications with noise (DBSCAN), or Jacobian clustering may be used instead of the Euclidean distance.

According to another embodiment, the attack grouping unit 200 may perform automatic clustering of data in a latent space based on deep learning of a TCN Variational Auto Encoder (VCE) technique.

A Variational Auto Encoder (VAE) is a type of generative model, and is primarily used for dimensionality reduction, data generation, data reconstruction, correction in latent space, and clustering. The key idea of the VAE is to map data into a low-dimensional latent space and learn a probabilistic distribution for data generation and transformation.

Because the VAE learns the normal patterns of time-series data, it may be used for anomaly detection and event classification tasks by being combined with a TCN. The VAE is a deep-learning model based on unsupervised learning, and when input is received, an encoder extracts a latent z (inference process) and the extracted latent z is used for the process of reconstructing data (generation process) through a decoder. The VAE is primarily based on probabilistic methodology and variational inference.

FIG. 14 is an exemplary view of attack grouping according to another embodiment.

Referring to FIG. 14, the TCN-VAE may be configured with an encoder (TCN-Encoder) 211 for mapping time-series data into a low-dimensional latent space and a decoder (TCN-Decoder) 212 for mapping a point in the latent space into an original data space.

That is, the encoder 211 maps input data to the probability distribution of the latent space.

The decoder (TCN-Decoder) 212 serves to reconstruct data in the original data space by using the points sampled from the latent space. The decoder is used to generate or transform data in the latent space.

Here, the probability distribution of the latent space is one of the key ideas of the TCN-VAE, and the data representation in the latent space is modeled as a probability distribution, in which case the probability distribution in the latent space is generally assumed to be a normal distribution. This probability distribution is used to generate data.

Here, when it maps data to the latent space in learning representations of the latent space, the VAE learns the mean and variance of the probability distributions. Accordingly, various data representations may be generated when sampling from the latent space is performed.

The TCN-VAE learns the probability distribution of the latent space using variational inference. In this process, Kullback-Leibler divergence (KL-divergence) is minimized so as to approximate the real data distribution and the probability distribution of the latent space.

The TCN-VAE generates new data by probabilistically sampling data from the latent space. Accordingly, the VAE is used for data generation and transformation.

With regard to correction in the latent space, the TCN-VAE is a powerful tool capable of manipulating and correcting data points in the latent space, and it may change the characteristics of data and manipulate the data in a desired direction.

With regard to clustering, the TCN-VAE provides functionality for grouping data in the latent space into a cluster, whereby data may be classified into similar groups.

That is, the data cluster obtained through the TCN-VAE and the MITRE ATT&CK Matrix are mapped to each other and data is grouped into the cluster. Accordingly, it is possible to provide the characteristics of information about various cyberattacks to a SIEM administrator and automatically recommend a response to an attack.

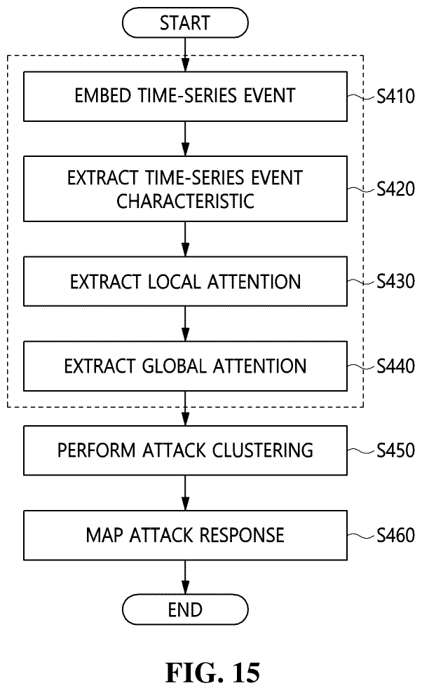

FIG. 15 is a flowchart for explaining a method for detecting a cyberattack according to an embodiment.

Referring to FIG. 15, the method for detecting a cyberattack according to an embodiment may include extracting at least one critical event based on the probabilities that pieces of input time-series event data in a predetermined sliding window unit contribute to occurrence of a subsequent event at steps S410 to S440 and clustering cyberattack characteristics based on the extracted at least one critical event at step S450.

Here, extracting the at least one critical event may include embedding the pieces of input time-series event data into predetermined vectors, respectively, at step S410 and extracting the time-series characteristics of the vectors through at least one Temporal Convolutional Network (TCN) at step S420.

Here, extracting the at least one critical event may include performing local attention extraction at step S430 for extracting a critical event from pieces of time-series event data included in a context input from a single device.

Here, extracting the at least one critical event may further include performing global attention extraction at step S440 for extracting a critical event based on the correlation from pieces of time-series event data respectively included in multiple contexts input from multiple devices.

Here, global attention extraction at step S440 may be configured with operations of two SE-NETs.

Here, global attention extraction at step S440 may be configured with an Efficient Channel Attention Net (ECA-NET).

Here, extracting the at least one critical event may further include performing learning in advance such that loss for the probability of occurrence of a final event is minimized after normalization of the sum of the vectors of the extracted critical events.

Here, clustering the cyberattack characteristics at step S450 may comprise performing clustering into a group with the minimum distance between a cluster vector and an extracted attention vector according to an embodiment.

Here, clustering the cyberattack characteristics at step S450 may comprise clustering data in a latent space based on deep learning of a TCN Variational Auto Encoder (VAE) technique according to another embodiment and may be configured with a TCN-VAE including an encoder for mapping time-series data into a low-dimensional latent space and a decoder for mapping a point in the latent space into an original data space.

Here, the method for detecting a cyberattack according to an embodiment may further include recommending a response to an attack based on the MITRE ATT&CK Matrix mapped to the clustered group at step S460.

Meanwhile, the clustering method for detecting and analyzing a cyberattack may be progressively improved in the order of “Auto-Encoder”, “TCN-VAE”, “TCN-AAE”, “TCN-GMM-WGAN” and “C-TCN-GMM-WGAN”. After the objective and problems of each method are examined first, the C-TCN-GMM-WGAN method finally proposed in the embodiment will be described.

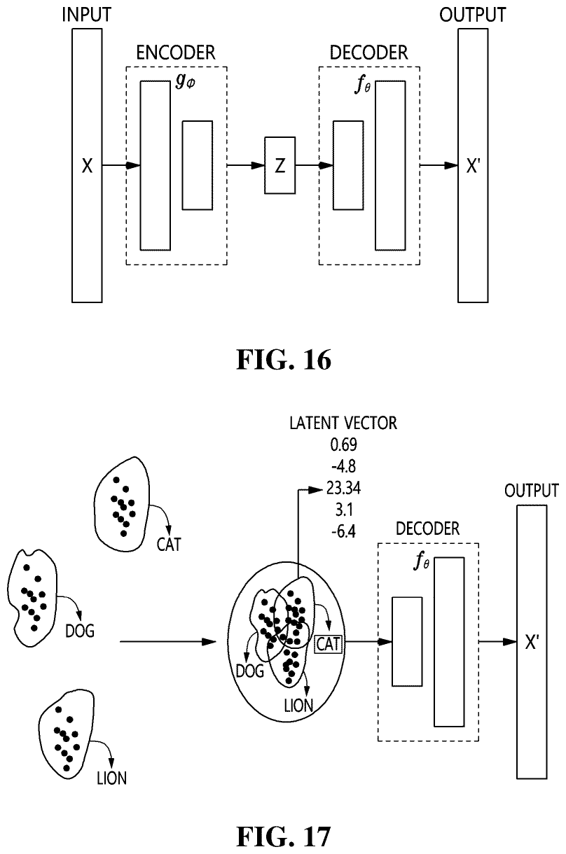

FIGS. 16 and 17 are views for explaining a clustering method using auto-encoder.

The clustering method using auto-encoder reduces the dimensionality of data through unsupervised learning to extract important features of the data, thereby performing clustering.

Referring to FIGS. 16 and 17, the auto-encoder is configured with an encoder for representing input data in a latent space and a decoder for reconstructing the original data in the latent space. This configuration enables latent features of data to be compressed to vectors, and similar data points are grouped into a cluster using these vectors.

Auto-encoder-based clustering is useful to discover the inherent structure of data and to group data points with a similar pattern based on the structure. Particularly, auto-encoder-based clustering may be useful for a high-dimensional complex dataset.

Therefore, auto-encoder-based clustering is a powerful tool capable of performing effective clustering based on the similarity between data points while minimizing data reconstruction loss.

However, existing auto-encoders compress input data into a latent space with fixed dimensionality, and in this process, the complexity and diversity of the data may be misrepresented. That is, the distribution in the latent space does not adequately reflect the distribution of the input data, which may degrade the quality of the reconstructed data.

Also, the sampling process in the latent space is very important for auto-encoders, but samples generated in this process do not occasionally follow a continuous distribution in the latent space. This is because latent vectors are not uniformly distributed across the entire latent space when the encoder learns latent representations of data. Accordingly, the non-uniform distribution causes the decoder to reconstruct valid output only in some regions of the latent space, and when generating a new data point, the decoder may generate unrealistic or meaningless output.

In order to solve the architecture of auto-encoder and the sampling problem in the latent space, TCN-VAE is introduced.

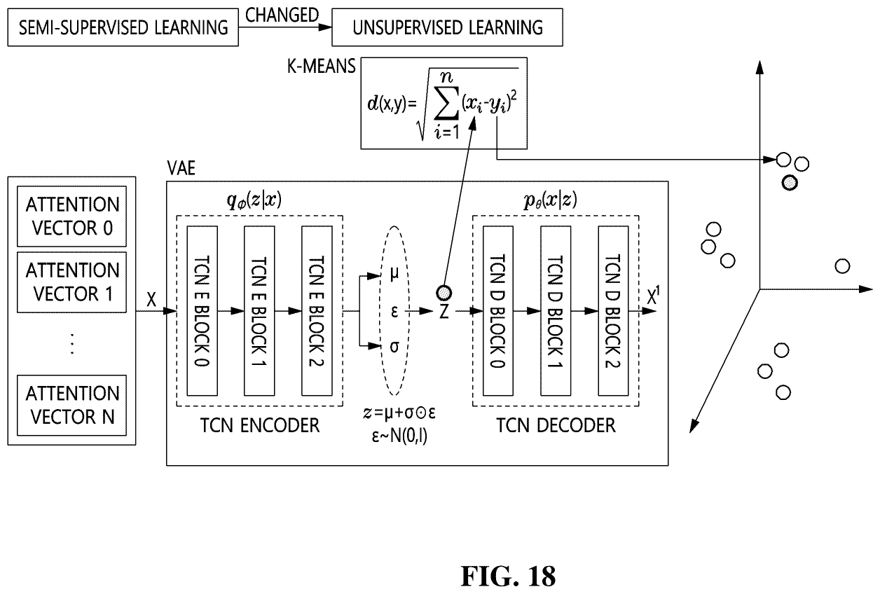

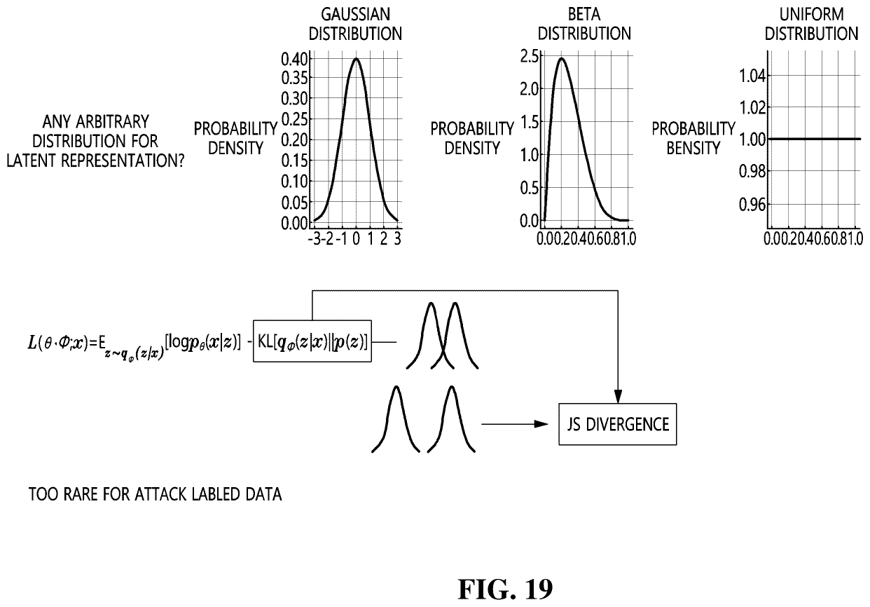

FIGS. 18 and 19 are views for explaining a clustering method using TCN Variational Auto Encoder (TCN-VAE).

Referring to FIG. 18, the VAE maps input data into a probabilistic latent space, thereby modeling the generative characteristics of the data. In order to model the probabilistic characteristics of the input data, the VAE adopts a probability distribution in the latent space. Accordingly, the model may also learn uncertainty of data, and more diverse and realistic data may be regenerated.

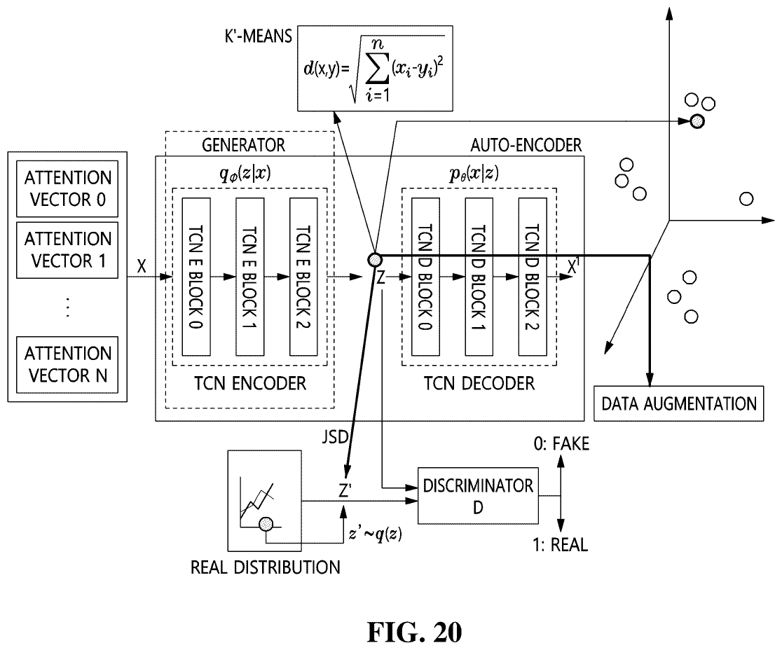

Three problems are pointed out below with refence to FIG. 19, and how TCN-AAE to be described with reference to FIG. 20 solves these problems will be described.

First, the TCN-VAE assumes that variables in the latent space follow only a normal distribution. This causes the complex distribution of real data to be limitedly represented and limits the versability and flexibility of the model. For example, it may not be applied to probability distributions (a uniform distribution, a beta distribution, and a Poisson distribution) other than the normal distribution.

Also, the TCN-VAE reduces the difference between a prior distribution and the distribution of latent variables generated by the encoder by minimizing reconstruction loss and KL divergence. In this process, Jenssen-Shannon Divergence (JSD) was used first, but it is replaced with KL divergence for the convenience of calculation and theoretical advantages. However, KL divergence has a problem because it measures how well one distribution explains another distribution, unlike JSD that measures the similarity between two distributions.

Also, data imbalance causes a serious problem in the cybersecurity field, and this is because there is much more normal behavior data than malicious behavior data. This imbalance in classes may degrade the performance of a machine-learning model and may prevent the model from properly learning cyberattack data, which is the minority class.

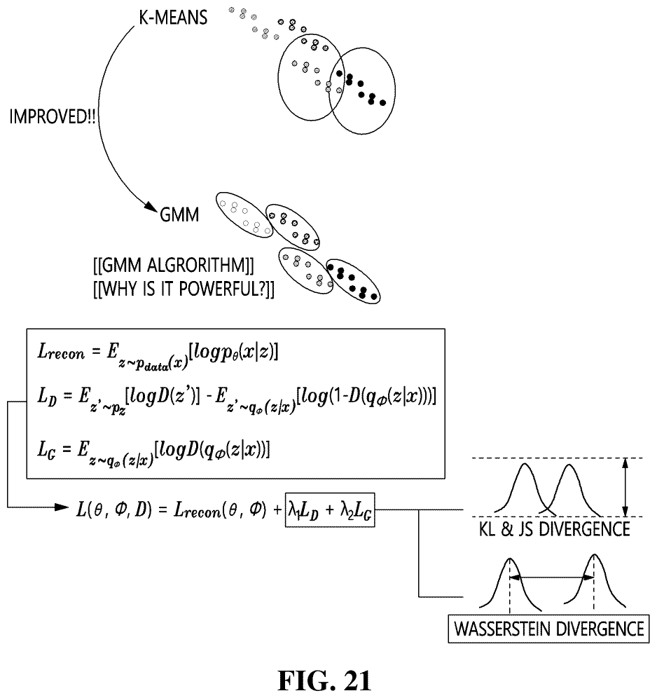

FIGS. 20 and 21 are views for explaining a clustering method using TCN Adversarial Auto Encoder (TCN-AAE).

The TCN-AAE illustrated in FIG. 20 is a variant of the TCN-VAE illustrated in FIG. 18 and improves the stability and reproducibility of a model by introducing the idea of Generative Adversarial Network (GAN).

The TCN-AAE adopts an adversarial learning technique to enforce the distribution of latent variables generated by an encoder to become similar to a prior distribution. That is, it may be applied to various probability distributions (a uniform distribution, a beta distribution, and a Poisson distribution) other than a normal distribution. Accordingly, the representation in the latent space may be improved, and more diverse data may be effectively regenerated.

However, the TCN-AAE model uses JSD to minimize the distance between the real data distribution and the generated data distribution, and JSD has a problem in which it is unstable or learning is not performed when the distributions do not sufficiently overlap (when the distributions are distant or infinitely distant from each other).

Also, K-means clustering is a simple algorithm that is widely used, but it has some limitations.

K-means assumes that clusters have a circular shape. This causes a problem in which clustering cannot be effectively performed when the real data distribution is not circular, that is, when the cluster is elliptical or elongated.

Also, the K-means treats all data points uniformly when calculating the center of the cluster.

That is, when an outlier is included, the outlier may greatly influence the center of the cluster. The K-means assumes that all clusters are roughly similar in size and density. This may be inefficient when clusters are different in density or size in real data. The K-means allocates each data point to only one cluster (hard clustering). This does not consider the possibility of a data point included in multiple clusters.

Accordingly, Gaussian Mixture Model (GMM) clustering is applied instead of the K-means. The GMM clustering method is a method of modeling each cluster to a Gaussian distribution (normal distribution). The GMM clustering method assumes that data is configured with the sum of multiple Gaussian distributions, and each of the Gaussian distributions represents a cluster. GMM clustering softly clusters data by estimating the probability that each data point is included in each cluster.

GMM clustering initializes the mean, covariance, and mixing coefficient of each cluster. This may be arbitrarily set or determined using a heuristic method. At the Expectation (E) stage, the probability that each data point is included in each cluster is calculated based on the given parameters (the mean, the covariance, and the mixing coefficient). This probability is determined depending on how well the data point fits each Gaussian distribution.

At the Maximization (M) stage, the parameters (the mean and covariance) of the cluster are updated using the probability of a data point belonging to each cluster, which is calculated at the E stage. This stage is performed by recalculating the mean and the covariance in consideration the weight of the data point. The E stage and the M stage are continuously repeated until the change in the parameter becomes equal to or less than a specific threshold value.

The K-means assumes that clusters have a circular shape, but the GMM may model an elliptical cluster. This is because the GMM considers the covariance of each cluster, and the GMM may better reflect the real data distribution.

The GMM provides the probability that a data point is included in multiple clusters. This is useful when the cluster to which each data point belongs is not clearly identified, and enables the uncertainty of the data to be better managed.

The GMM has a structure that can easily increase the number of clusters. It may be applicable to datasets having various sizes and shapes by adjusting the complexity of the model. The K-means is very sensitive to outliers, but the GMM may reduce the influence of outliers by using weights assigned to individual data points.

Because of these characteristics, the GMM is more flexible than the K-means and is a powerful clustering technique capable of better processing the complexity of real data.

Also, a data augmentation method using Generative Adversarial Network (GAN) may be an effective solution for solving the data imbalance problem with the TCN-VAE (where the amount of normal behavior data is much greater than the amount of malicious behavior data).

The data augmentation method using GAN includes two main components, which are a generator and a discriminator. The generator attempts to generate fake data that is difficult to distinguish from real data, and the discriminator tries to determine whether the provided data is real or generated. The generator starts with noise and generates new data similar to real cyberattack data. This process is a process of learning characteristics of real cyberattack data to imitate the real cyberattack data and generating new data based thereon. As shown in the drawing, a lot of additional attack data may be generated to supplement the insufficient attack data by passing z generated in the generator through a decoder.

The fake attack data generated in this way is added to the existing training dataset, thereby mitigating the imbalance between classes. The augmented dataset may help the model better understand and learn cyberattack patterns. The model may experience various forms of attacks through data augmentation, and this contributes to improving the generalization ability and the robust ability of the model. Also, this may reduce the risk of overfitting and improve prediction for a minority class.

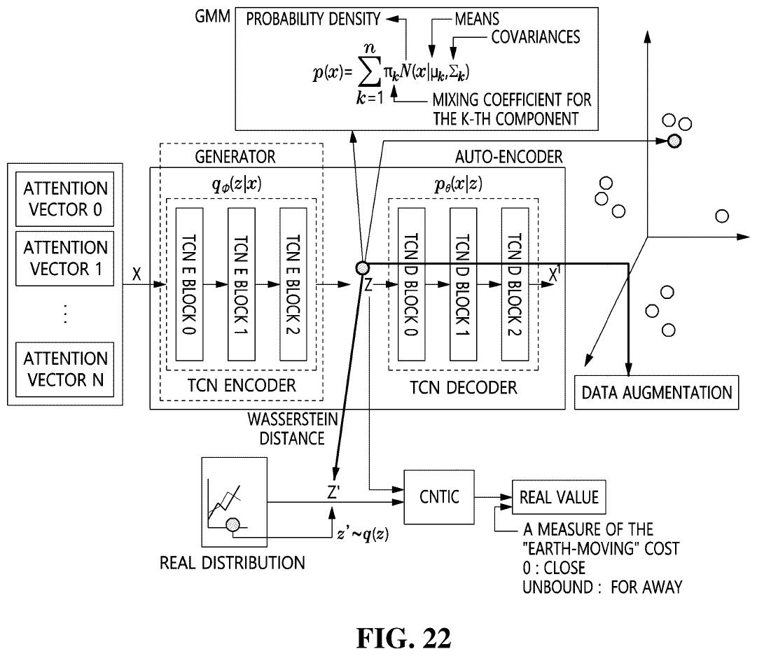

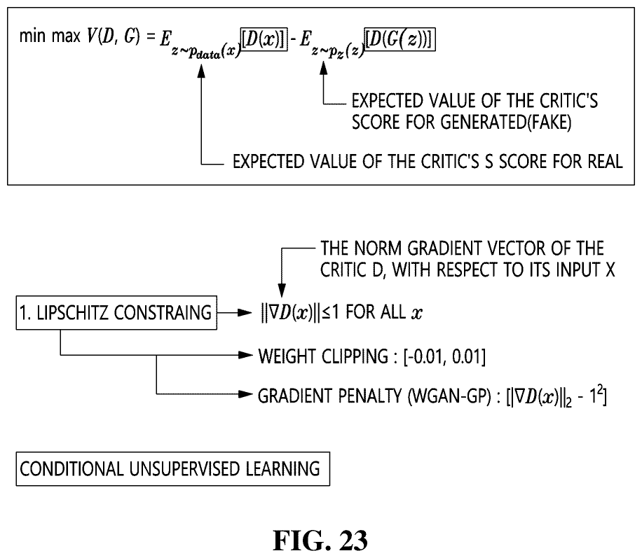

FIGS. 22 and 23 are views for explaining a clustering method using TCN GMM Wasserstein GAN (TCN-GMM-WGAN).

The WGAN illustrated in FIG. 22 is introduced to improve the training stability of GAN. The clustering method using TCN-GMM-WGAN may change a loss function, stabilize training of the GAN, and mitigate mode collapse. The Wasserstein distance may be helpful to overcome the limitation of the distance measurement method used in the existing GAN.

The conventional GAN models mainly use Jensen-Shannon divergence (JSD) to measure the distance between a real data distribution and a generated data distribution. However, JSD is likely to cause the problem of gradient loss (mode collapse) in the region where the two distributions do not overlap each other, and as a result, the learning process may become unstable.

In comparison, the Wasserstein distance is also called “earth mover's distance” between two distributions and is calculated to minimize the “cost” required to convert one distribution to another distribution. This distance measurement method provides a useful gradient even when the supports of two distributions do not overlap each other. As a result, it greatly improves stability in the learning process and helps the model learn more diverse modes.

The Wasserstein GAN (WGAN) uses the Wasserstein distance as a loss function, thereby stabilizing learning of a GAN. The loss function of the WGAN is formulated as a problem of optimal transfer between a generator and a discriminator. The discriminator estimates the Wasserstein distance between two data distributions, and the generator is trained to minimize the distance. In this process, the discriminator no longer performs binary classification for distinguishing between real data and generated data. Instead, the discriminator serves to numerically evaluate the distance from the real data.

Consequently, the use of the WGAN enables clustering to provide more accurate and reliable results. The WGAN makes learning more stable than conventional GANs, improves the quality of generated images, and effectively solves a mode collapse problem, thereby obtaining the capability of better generating diverse data. This may greatly improve the performance of the GAN especially for complex datasets.

FIG. 23 explains a method of improving clustering efficiency by using GMM and the Wasserstein distance.

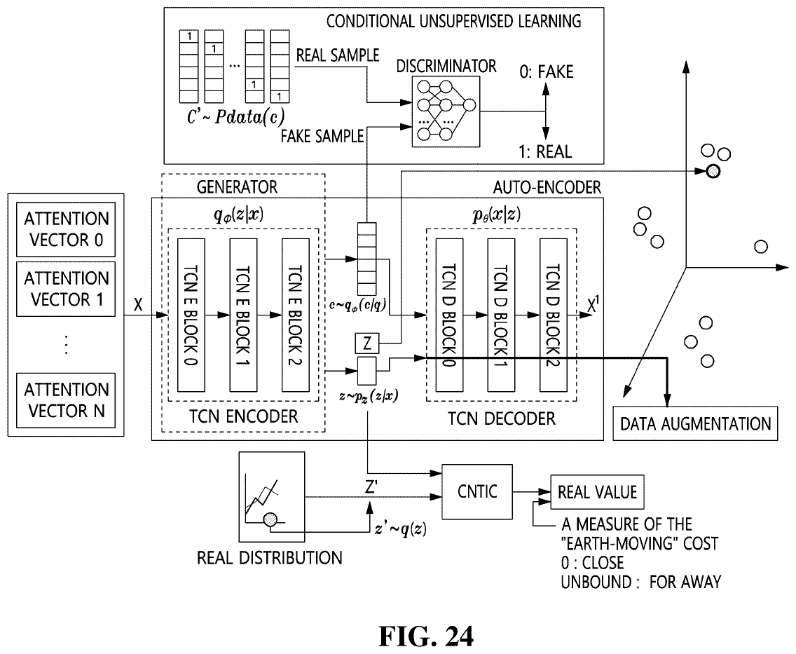

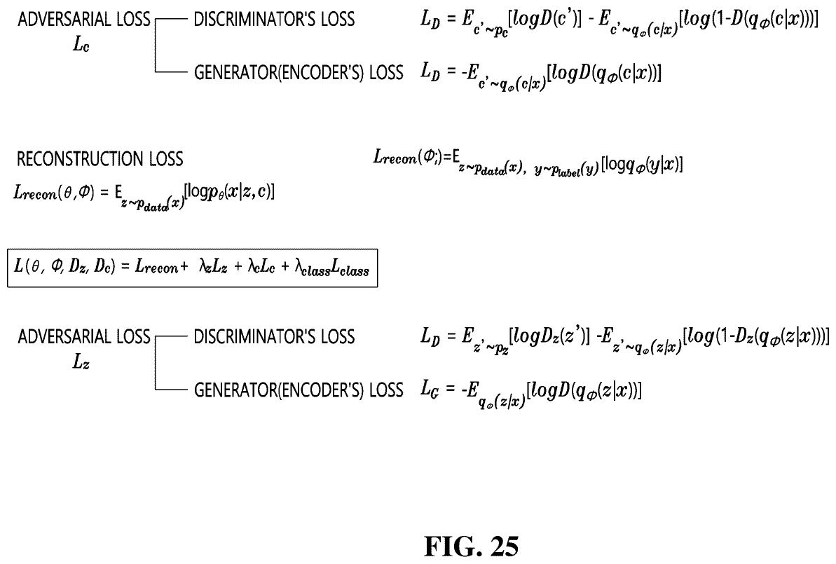

FIGS. 24 and 25 are views for explaining a clustering method using conditional TCN-GMM-WGAN.

Referring to FIG. 24, conditional Generative Adversarial Networks (conditional WGANs) are techniques of controlling a generation process by adding conditional information to the existing GAN framework. The clustering method based thereon uses the label or specific feature of data as a condition to generate specific types of data. When a conditional WGAN is applied to clustering, the subdivided characteristics of data are reflected, whereby more sophisticated and meaningful classification into groups is enabled.

The conditional WGAN uses additional labels or attribute information as input for each data point. For example, the category of an image may be a condition in an image dataset. This information is provided to both a generator and a discriminator so as to induce generated data to satisfy the given condition.

The generator receives random noise and a conditional label and generates data satisfying the condition. In this process, the generator learns the characteristics of data meeting the condition and attempts to generate data that meets the characteristics.

The discriminator receives real data and generated data and determines whether data is real or generated. Also, the discriminator evaluates whether the data meets the given conditions. By double-checking the conditions, the generator evolves to generate data more accurately satisfying the conditions.

At the final stage, the accuracy of clustering may be further improved by applying the conditional WGAN. Using conditional information, only a specific type of data can be generated, whereby analysis focused on a specific group is enabled in clustering.

Also, many hidden subgroups may be discovered in a complex dataset by setting various conditions, and more detailed data structure may be understood. This enables application of various types of conditions, so the approach for clustering may be more diversified and customized.

Clustering using a conditional WGAN is useful when a label is clear or when it is important to group data depending on a specific condition. This may be used for the method of recommending a response to an attack based on the MITRE ATT&CK Matrix mapped to the clustered group. Consequently, this method clusters data depending on the given label or condition, thereby generating more subdivided and accurate cluster.

FIGS. 24 and 25 shows the final objective function and architecture of C-TCN-GMM-WGAN. The final objective function is represented as the sum of a reconnection loss function, the adversarial loss function of a latent vector z, the adversarial loss function of a clustering category (one-hot encoding) vector, and the loss function of data classified into a cluster as predicted.

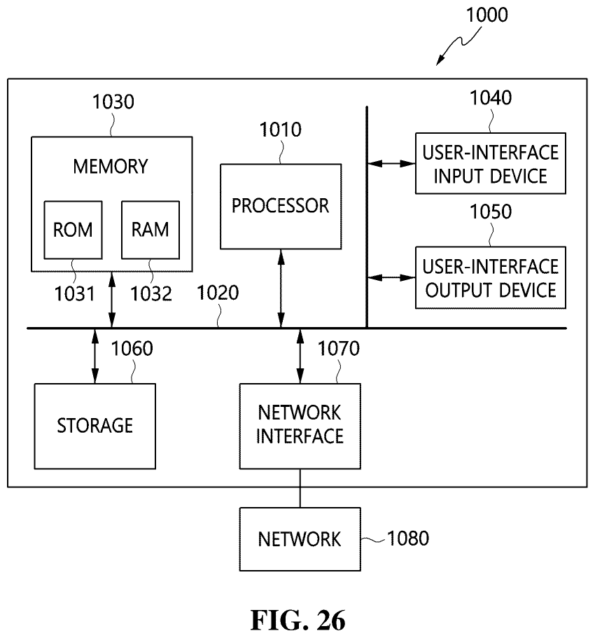

FIG. 26 is a view illustrating a computer system configuration according to an embodiment.

The apparatus 1 for detecting a cyberattack according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, an alert fatigue problem attributable to security alarm alerts may be solved.

That is, after classifying the characteristics of a series of time-series attack packets through clustering, if a series of attack actions matches a specific cluster group in the event of a real-time attack, an action is taken against the corresponding attack according to a response method set by a SIEM administrator, whereby alert fatigue may be mitigated.

According to the disclosed embodiment, a critical event may be identified based on the characteristics of a series of time-series attack packets.

According to the disclosed embodiment, a critical event may be identified based on the correlation of time-series attack packets input from multiple devices.

That is, a single time-series event is analyzed and categorized with a large number of correlated events using AI clustering technology so as to be used in various domains, including improvement in the accuracy of anomaly detection, reduction of alert fatigue, and proactive and predictive responses.

Also, it is possible to provide a SIEM administrator with the characteristics of alerts for various cyberattacks and to automatically recommend a response to an attack by mapping a data cluster obtained through TCN-VAE and the MITRE ATT&CK Matrix to each other and grouping data into clusters.

The MITRE ATT&CK Matrix is an essential resource for organizations, security researchers, and cybersecurity professionals to understand cyberthreats and strengthen defense and is used as basic references about threat intelligence, incident responses, and security operations. Also, as a threat environment changes, MITRE may update the matrix and add new tactics, techniques, and real-world observations.

Although the embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for detecting a cyberattack, comprising:
an attention extraction unit for extracting at least one critical event based on probabilities that pieces of input time-series event data in a predetermined sliding window unit contribute to occurrence of a subsequent event; and
an attack grouping unit for clustering cyberattack characteristics based on the extracted at least one critical event.

2. The apparatus of claim 1, wherein the attention extraction unit includes
an embedding unit for converting the pieces of input time-series event data into predetermined vectors, respectively; and
at least one Temporal Convolutional Network (TCN) for extracting time-series characteristics of the vectors.

3. The apparatus of claim 2, wherein the attention extraction unit includes
a local attention unit for extracting a critical event from pieces of time-series event data included in a context input from a single device.

4. The apparatus of claim 3, wherein the attention extraction unit further includes
a global attention unit for extracting a critical event based on a correlation from pieces of time-series event data respectively included in multiple contexts input from multiple devices.

5. The apparatus of claim 4, wherein the global attention unit is configured with operations of two Squeeze-and-Excitation Networks (SE-NETs).

6. The apparatus of claim 4, wherein the global attention unit is configured with an Efficient Channel Attention Net (ECA-NET).

7. The apparatus of claim 1, wherein the attention extraction unit is trained in advance such that loss for a probability of occurrence of a final event is minimized after a sum of vectors of extracted critical events is normalized.

8. The apparatus of claim 1, wherein the attack grouping unit performs clustering into a group with a minimum distance between a cluster vector and an extracted attention vector.

9. The apparatus of claim 1, wherein the attack grouping unit clusters data in a latent space based on deep learning of a Temporal Convolutional Network Variational Auto Encoder (TCN VAE) technique and is configured with a TCN-VAE including an encoder for mapping time-series data into a low-dimensional latent space and a decoder for mapping a point in the latent space into an original data space.

10. The apparatus of claim 1, further comprising:
a response mapping unit for recommending a response to an attack based on a MITRE ATT&CK Matrix mapped to a clustered group.

11. A method for detecting a cyberattack, comprising:
extracting at least one critical event based on probabilities that pieces of input time-series event data in a predetermined sliding window unit contribute to occurrence of a subsequent event; and
clustering cyberattack characteristics based on the extracted at least one critical event.

12. The method of claim 11, wherein extracting the at least one critical event comprises
embedding the pieces of input time-series event data into predetermined vectors, respectively; and
extracting time-series characteristics of the vectors through at least one Temporal Convolutional Network (TCN).

13. The method of claim 12, wherein extracting the at least one critical event comprises
performing local attention extraction for extracting a critical event from pieces of time-series event data included in a context input from a single device.

14. The method of claim 13, wherein extracting the at least one critical event further comprises
performing global attention extraction for extracting a critical event based on a correlation from pieces of time-series event data respectively included in multiple contexts input from multiple devices.

15. The method of claim 14, wherein performing the global attention extraction is configured with operations of two Squeeze-and-Excitation Networks (SE-NETs).

16. The method of claim 14, wherein performing the global attention extraction is configured with an Efficient Channel Attention Net (ECA-NET).

17. The method of claim 11, wherein extracting the at least one critical event comprises performing learning in advance such that loss for a probability of occurrence of a final event is minimized after a sum of vectors of extracted critical events is normalized.

18. The method of claim 11, wherein clustering the cyberattack characteristics comprises performing clustering into a group with a minimum distance between a cluster vector and an extracted attention vector.

19. The method of claim 11, wherein
clustering the cyberattack characteristics comprises clustering data in a latent space based on deep learning of a Temporal Convolutional Network Variational Auto Encoder (TCN VAE) technique; and
clustering the cyberattack characteristics is configured with a TCN-VAE including an encoder for mapping time-series data into a low-dimensional latent space and a decoder for mapping a point in the latent space into an original data space.

20. The method of claim 11, further comprising:
recommending a response to an attack based on a MITRE ATT&CK Matrix mapped to a clustered group.
